(19) United States
(12) Patent Application Publication
(10) Pub. No.: US 2025/0260087 A1
(43) Pub. Date: Aug. 14, 2025

(54) REPLACEABLE BATTERY

(71) Applicant: TOYOTA JIDOSHA KABUSHIKI KAISHA, Toyota-shi (JP)

(72) Inventors: Kota NAKAMURA, Toyota-shi (JP); Yutaroh Gotoh, Toyota-shi (JP); Yukinari Tanabe, Okazaki-shi (JP); Masataka Ogushi, Nisshin-shi (JP); Taro Matsushita, Toyokawa-shi (JP); Shinnosuke Izumi, Kitagunma-gun (JP); Hiroaki Ishikawa, Toyota-shi (JP); Hiroki Yamato, Kariya-shi (JP)

(73) Assignee: TOYOTA JIDOSHA KABUSHIKI KAISHA, Toyota-shi (JP)

(21) Appl. No.: 18/987,659

(22) Filed: Dec. 19, 2024

(30) Foreign Application Priority Data
Feb. 9, 2024 (JP) 2024-018929

(51) Int. Cl. H01M 10/6554; H01M 10/653; H01M 50/209; H01M 50/249; H01M 50/256; H01M 50/367

(52) U.S. Cl. CPC H01M 10/6554; H01M 10/653; H01M 50/209; H01M 50/249; H01M 50/256; H01M 50/367

(57) ABSTRACT

According to the present disclosure, a replaceable battery includes a cell stack having a rectangular parallelepiped shape, in which a plurality of battery cells are stacked, a case for accommodating the cell stack, and a pair of rails fixed to a lower side of a bottom plate of the case and extending in a longitudinal direction of the case, in which the replaceable battery is configured to be slid in the longitudinal direction and removably mounted on a vehicle and. A metal member for heat removal is provided in an upper side of the bottom plate and in a lower side of the cell stack, and the metal member is disposed between the pair of rails so as to extend, in a bar shape, in the longitudinal direction of the case.

### CROSS REFERENCE TO RELATED APPLICATIONS

This application is based upon and claims the benefit of priority from Japanese patent application No. 2024-018929, filed on Feb. 9, 2024, the disclosure of which is incorporated herein in its entirety by reference.

### BACKGROUND

The present disclosure relates to a replaceable battery.

Patent Literature 1 discloses a replaceable battery removably mounted on a vehicle.
Patent Literature 1: Japanese Unexamined Patent Application Publication No. 2019-169337

### SUMMARY

The inventors have developed a replaceable battery having a configuration in which a cell stack having a rectangular parallelepiped shape is accommodated in a case and the battery is made slidable by a pair of rails extending in a longitudinal direction at the lower side of the bottom plate of the case.

The inventors are considering installing a metal member for heat removal at the lower side of a cell stack. Here, if the replaceable battery falls and lands with its bottom surface down, there is a possibility that the cell stack may be damaged by the metal member depending on the shape of the metal member and the arrangement relationship with the rails.

The present disclosure is made in view of such circumstances, and provides a replaceable battery capable of suppressing damage to a cell stack caused by a metal member for heat removal even if the cell stack falls.

According to the present disclosure, a replaceable battery includes:
a cell stack having a rectangular parallelepiped shape, in which a plurality of battery cells are stacked;
a case for accommodating the cell stack; and
a pair of rails fixed to a lower side of a bottom plate of the case and extending in a longitudinal direction of the case,
in which the replaceable battery is configured to be slid in the longitudinal direction and removably mounted on a vehicle,
in which a metal member for heat removal is provided on an upper side of the bottom plate and on a lower side of the cell stack, and
in which the metal member is disposed between the pair of rails so as to extend, in a bar shape, in the longitudinal direction of the case.

In the replaceable battery according to the present disclosure, the metal member for heat removal is provided on the upper side of the bottom plate and on the lower side of the cell stack and is disposed between the pair of rails extending in the longitudinal direction of the case so as to extend, in a bar shape, in the longitudinal direction of the case.

Therefore, in the case where the replaceable battery falls and lands with its bottom surface down, the bottom plate of the case pushed by the metal member provided at the lower side of the cell stack can be deformed so that the bottom plate protrudes downward, and the damage to the cell stack caused by the metal member can be suppressed.

The metal member may be provided at the center of the cell stack in the widthwise direction of the cell stack and disposed centrally between the pair of rails. With such a configuration, damage to the cell stack caused by the metal member can be suppressed more effectively.

The pair of rails may be provided at positions corresponding to both ends of the cell stack in the widthwise direction of the cell stack. With such a configuration, damage to the cell stack caused by the metal member can be suppressed more effectively.

The center of the cell stack in the widthwise direction of the cell stack may be offset from a center of the case in the widthwise direction of the case. With such a configuration, an electronic device or the like can be arranged in a spatial area between the cell stack and the side plate of the case while reducing the height of the case.

The metal member may be an aluminum-based metal. With such a configuration, the replaceable battery can be reduced in weight.

According to the present disclosure, it is possible to provide a replaceable battery capable of suppressing damage to a cell stack caused by a metal member for heat removal even if the cell stack falls.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view showing an external appearance of a replaceable battery according to a first embodiment;

FIG. 2 is an enlarged schematic perspective view of the periphery of a front case provided at the front end of the replaceable battery according to the first embodiment;

FIG. 3 is an enlarged schematic perspective view of the periphery of a rear case provided at the rear end of the replaceable battery according to the first embodiment;

FIG. 4 is a schematic perspective view showing a modified example of a grip-handle 131;

FIG. 5 is a flowchart showing a flow of assembly of the replaceable battery according to the first embodiment;

FIG. 6 is a schematic perspective view for explaining the flow of assembly of the replaceable battery according to the first embodiment;

FIG. 7 is a schematic perspective view for explaining the flow of assembly of the replaceable battery according to the first embodiment; and

FIG. 8 is a schematic cross-sectional view of the replaceable battery according to the first embodiment.

### DESCRIPTION OF EMBODIMENTS

The present disclosure will be described hereinafter through embodiments of the present disclosure. However, the disclosure according to the claims is not limited to the following embodiments. Further, all the components/structures described in the embodiments are not necessarily essential as means for solving the problem. For the clarification of the description, the following descriptions and the drawings are partially omitted and simplified as appropriate. The same elements are denoted by the same reference numerals or symbols throughout the drawings, and redundant descriptions are omitted as necessary.

### First Embodiment

### Configuration of Replaceable Battery 1

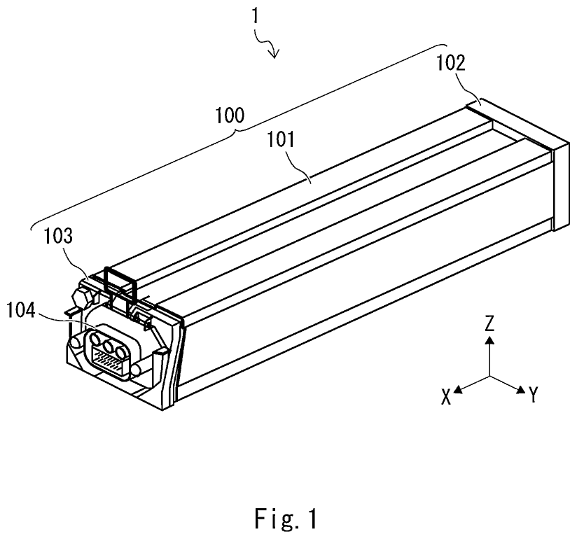

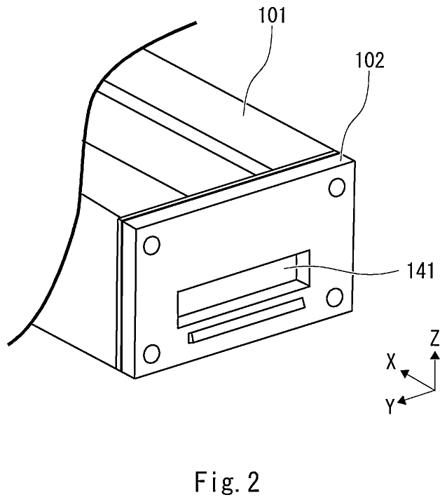

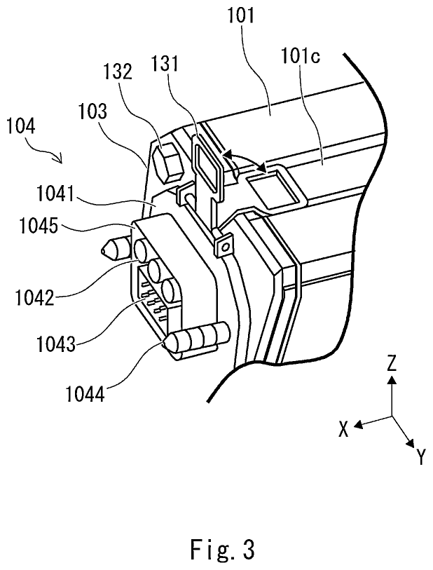

First, a configuration of a replaceable battery 1 according to a first embodiment will be described with reference to FIGS. 1 to 3. FIG. 1 is a schematic perspective view showing an external appearance of the replaceable battery 1 according to the first embodiment. FIG. 2 is an enlarged schematic perspective view of the periphery of a front case provided at the front end of the replaceable battery according to the first embodiment. FIG. 3 is an enlarged schematic perspective view of the periphery of a rear case provided at the rear end of the replaceable battery according to the first embodiment.

The replaceable battery 1 is also referred to as a battery pack, a battery module, or the like, and is removably mounted on a vehicle such as a battery electric vehicle (BEV) driven by a motor using electricity as a power source. The size and the weight of the replaceable battery 1 are reduced so that, for example, a worker (including a work robot and the like) can easily insert and remove the replaceable battery 1 into and from a battery electric vehicle (BEV).

Note that it is needless to say that right-handed XYZ orthogonal coordinates shown in FIGS. 1 to 3 are shown only for the sake of convenience in describing the positional relation among the components. Normally, in, for example, FIG. 1, the Z-axis positive direction denotes a vertically upward direction, and the XY plane denotes a horizontal plane, which direction and plane are the same throughout the drawings.

As shown in FIG. 1, in the replaceable battery 1, the outer shape of a rectangular parallelepiped shape is defined by a case 100 for accommodating a cell stack and the like. The case 100 includes a case main body (a main body part) 101 having a rectangular tube shape, a front case 102 serving as a lid part for closing one opening end of the case main body 101 (an opening part of the case main body 101 at the front end thereof), and a rear case 103 serving as a lid part for closing the other opening end of the case main body 101 (an opening part of the case main body 101 at the rear end thereof).

Further, a connector 104 formed so that it protrudes outward so as to be connectable to a connector on the vehicle side is provided in the rear case 103 that is provided at the rear end of the replaceable battery 1.

Although not shown, for example, a worker accommodates the replaceable battery 1 in the storage space of the vehicle while sliding the replaceable battery 1 in the longitudinal direction (the X-axis direction), whereby the connector 104 of the replaceable battery 1 is connected to the connector on the vehicle side.

As shown in FIG. 2, a pull-handle 141 for sliding the replaceable battery 1 is provided in the front case (first lid part) 102. The pull-handle 141 shown in FIG. 2 is a recessed pull-handle. However, it is not limited to a particular kind of handle. The worker can slide the replaceable battery 1 by holding the pull-handle 141 and then pushing or pulling the replaceable battery 1.

Further, the replaceable battery 1 can be placed on, for example, a carriage and then conveyed. When the replaceable battery 1 is taken out of the carriage so as to be accommodated in the storage space, the height of the carriage is adjusted to that of the storage space and the pull-handle 141, so that the replaceable battery 1 is accommodated in (i.e., slid into) the storage space. On the other hand, when the replaceable battery 1 is taken out of the storage space so as to be placed on the carriage, the height of the carriage is adjusted to that of the storage space and the pull-handle 141 is pulled, so that the replaceable battery 1 is taken out of the storage space.

As shown in FIG. 3, in addition to the connector 104, a grip-handle 131 and a relief valve 132 are provided in the rear case (second lid part) 103. Note that the connector 104 includes a base 1041, a high-voltage terminal 1042, a low-voltage terminal 1043, a pin 1044 for alignment, and a cover 1045 made of metal.

The base 1041 is disposed in the main surface of the rear case 103.

All of the high-voltage terminal 1042, the low-voltage terminal 1043, and the pin 1044 for alignment are formed so that they protrude outward from the main surface of the base 1041.

The cover 1045 is formed so that it surrounds the side surfaces of the high-voltage terminal 1042 and the low-voltage terminal 1043.

The high-voltage terminal 1042 is a terminal for transmitting electricity output from a cell stack accommodated in the case 100 of the replaceable battery 1 to a vehicle on which the replaceable battery 1 is mounted.

The low-voltage terminal 1043 is a terminal for transmitting a control signal from a vehicle to the replaceable battery 1, and for transmitting a signal indicative of a result of monitoring of a cell stack (a result of a voltage measurement etc.) from the replaceable battery 1 to a vehicle.

As shown in FIG. 3, the grip-handle 131 is provided rotatably around a shaft extending along the upper edge of the rear case 103, and is placed on an upper surface of the case main body 101 (i.e., an upper surface of the top plate) when not in use. Therefore, the replaceable battery 1 can be carried by use of the grip-handle 131 without interrupting the connection of the connector 104.

Here, as will be described in detail later, in the replaceable battery 1 according to this embodiment, the cell stack having a large mass is disposed so as to be close to one side plate in the case 100. That is, when a worker carries the replaceable battery 1, the worker may lose the balance of the replaceable battery 1 since the center of gravity thereof is shifted to one side.

On the other hand, in the replaceable battery 1, when a worker carries the replaceable battery 1, the worker can hold the rotatable grip-handle 131 with one hand and lift the replaceable battery 1, and at the same time hold, for example, the pull-handle 141 with the other hand and support the replaceable battery 1. Therefore, the worker can carry the replaceable battery 1 while keeping the replaceable battery 1 balanced.

The grip-handle 131 shown in FIG. 3 is a single plate-like member. However, it is not to be limited thereto. As shown in FIG. 3, a base part of the grip-handle 131 is provided so at be rotatable around a shaft extending along an upper edge of the rear case 103. A rectangular opening part is provided in a tip part of the grip-handle 131. A worker inserts his/her finger into the opening part, holds the grip-handle 131, and lifts the replaceable battery 1.

As shown in FIG. 3, a rib groove 101c is formed on the upper surface of the case main body 101 (i.e., the upper surface of the top plate) along the longitudinal direction (the X-axis direction) of the case main body 101. Therefore, the plate-like grip-handle 131 can be accommodated in the rib groove 101c when not in use. Thus, a worker can easily accommodate the replaceable battery 1 in the storage space of a vehicle. Further, the strength of the upper surface of the case main body 101 is improved as well by forming the rib groove 101c on the upper surface thereof.

Note that the thickness of the case main body 101 is preferably reduced, and the thickness of the rear case 103 is preferably larger than the thickness of the case main body 101. For example, a die-cast member is used as the rear case 103. This configuration improves the rigidity of the rear case 103, and also improves the workability when the grip-handle 131 is used. Further, it is possible to reduce the number of occurrences of deformation of the case 100 by providing the grip-handle 131 in the rear case 103 having a large thickness.

On the contrary, it is possible to reduce the weight of the case 100 by reducing the thickness of the case main body 101. Further, if gas is generated in the cell stack, the case main body 101 becomes deformed and swells outward, so that a rapid increase in the internal pressure of the case 100 can be suppressed.

The relief valve 132 discharges gas generated in the cell stack accommodated in the case 100 of the replaceable battery 1. As shown in FIG. 3, since the grip-handle 131 is provided in the central part of the upper edge of the rear case 103, the relief valve 132 is provided in the corner part of the upper edge of the rear case 103. Note that, in FIG. 3, the relief valve 132 is provided in the corner part of the upper edge of the rear case 103 on the Y-axis negative direction side. However, it may instead be provided in the corner part of the upper edge of the rear case 103 on the Y-axis positive direction side.

Note that, in replacing the replaceable battery 1, the worker works on the side of the front case 102 provided with the pull-handle 141. Even if gas is discharged from the relief valve 132 while replacing the replaceable battery 1, since the relief valve 132 is provided in the rear case 103 located via the replaceable battery 1 on the side of an area opposite to an area where the worker is present, the gas is discharged toward the area opposite to the area where the worker is present. Therefore, the safety of the worker can be ensured. In the case where the worker is a work robot or the like, adverse effects due to gas can be reduced.

Further, when a worker holds grip-handle 131 and pull-handle 141 and carries the replaceable battery 1, even if gas is discharged from relief valve 132, the gas is not discharged toward the worker. Therefore, the safety of the worker can be ensured.

Further, even when gas is discharged from the relief valve 132, the high-voltage terminal 1042 and the low-voltage terminal 1043 can be protected by the cover 1045 made of metal. While a plastic cover has a risk of erosion due to gas, the metal cover 1045 has no risk of erosion. Further, the metal cover 1045 has excellent durability, and as a result of this, it can be advantageously used, since the connector 104 is repeatedly inserted into and removed from the replaceable battery.

Although not shown, in a wall surface that faces the rear case 103 in the storage space of the vehicle in which the replaceable battery 1 is accommodated, an exhaust port through which gas discharged through the relief valve 132 is discharged to the outside via the vehicle is provided. The gas discharged from relief valve 132 is discharged from, for example, lower side of the vehicle to the outside of the vehicle through a duct connected to the exhaust port. Therefore, even if gas is discharged from the relief valve 132 in a state in which the replaceable battery 1 is accommodated in the storage space of the vehicle, the gas does not flow to an area where a worker is present, and thus the safety of the worker can be ensured.

### Modified Example of Grip-Handle 131

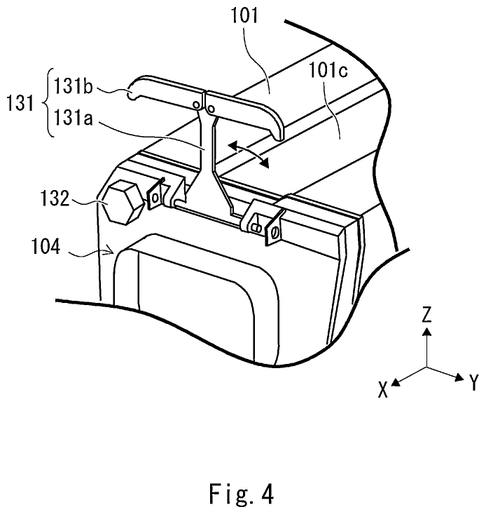

A modified example of the grip-handle 131 will be described below with reference to FIG. 4. FIG. 4 is a schematic perspective view showing the modified example of the grip-handle 131.

As shown in FIG. 4, the grip-handle 131 according to the modified example includes a support part 131a and a pair of grip parts 131b. The base part of the plate-like support part 131a is provided rotatably around a shaft extending along the upper edge of the rear case 103. Further, the base parts of the pair of grip parts 131b are rotatably connected to the tip part of the support part 131a. Therefore, in the grip-handle 131 according to the modified example shown in FIG. 4, the pair of grip parts 131b can be folded.

Although not shown, when the pair of grip parts 131b are not in use, the longitudinal direction thereof is parallel to the longitudinal direction of the support part 131a, and the pair of grip parts 131b are folded. In this state, the grip-handle 131 is placed on the upper surface of the case main body 101.

On the other hand, when the pair of grip parts 131b are in use, as shown in FIG. 4, they are rotated at an angle of about 90 degrees so that they move apart from each other to form a straight line and opened. As a result, as shown in FIG. 4, the grip-handle 131 forms a T-shape outline. The worker then grips the pair of grip parts 131b which are brought to an opened state forming a straight line.

Note that, in the grip-handle 131 shown in FIG. 4, the width of the tip part of the support part 131a is smaller than the width of the base part of the support part 131a. However, the width of the tip part of the support part 131a is not limited to a particular width, and may be equal to the width of the base part of the support part 131a.

### Assembly and Internal Configuration of Replaceable Battery 1

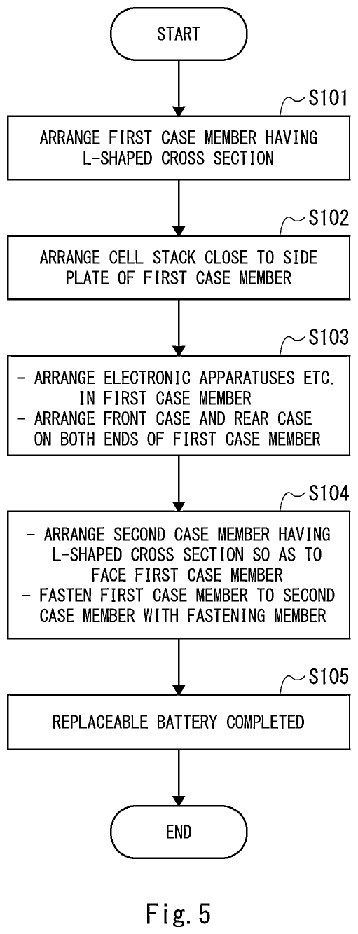

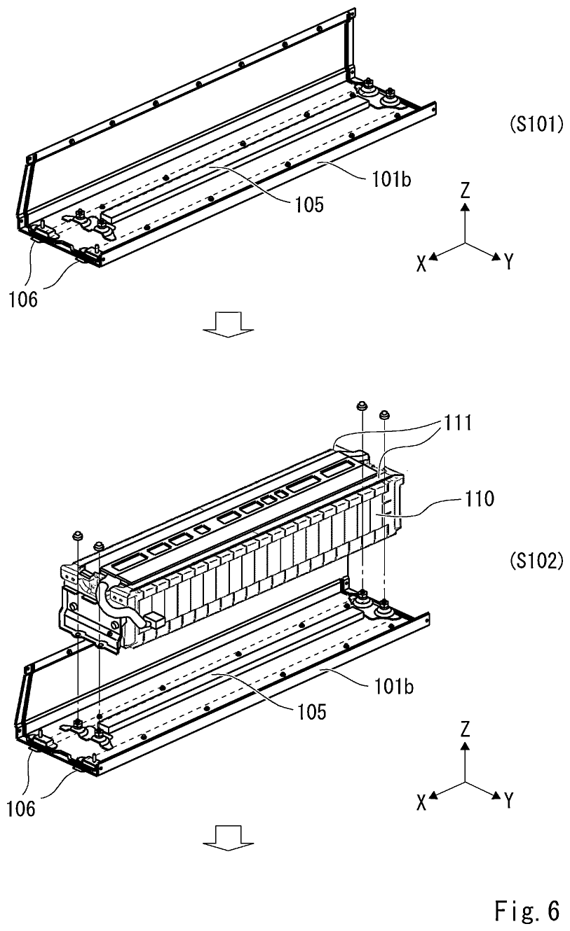

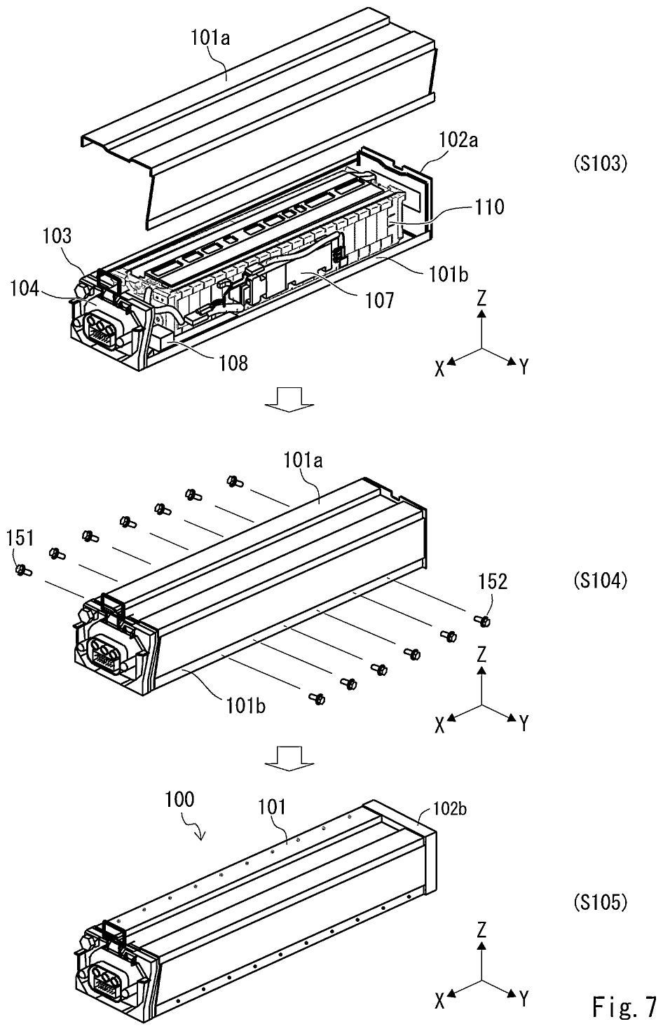

Next, assembly and the internal configuration of the replaceable battery 1 will be described with reference to FIGS. 5 to 7. FIG. 5 is a flowchart showing the assembly of the replaceable battery 1. FIGS. 6 and 7 are schematic perspective views for explaining the flow of the assembly of the replaceable battery 1. The display contents of Steps S101 to S105 shown in FIGS. 6 and 7 correspond to the result of the processes of Steps S101 to S105 shown in FIG. 5, respectively.

First, a lower case (a first case member) 101b forming the bottom plate and one side plate (a first side plate) of the case main body 101 is disposed (Step S101). The lower case 101b is formed so that the YZ cross section thereof has an L-shape and so that it extends along the X-axis direction.

As shown in FIG. 6, a pair of rails 106 extending along the longitudinal direction (the X-axis direction) of the lower case 101b are fixed to the lower side of the bottom plate of the lower case 101b (i.e., the case main body 101). Therefore, the replaceable battery 1 can be easily slid in the longitudinal direction. For example, the replaceable battery 1 is slid in the longitudinal direction along a guide provided in the vehicle.

Illustration of the rails 106 is omitted in the drawings other than FIG. 6.

On the other hand, as shown in FIG. 6, a rectangular bar-shaped metal member 105 is provided on an upper side of the bottom plate of the lower case 101b and is disposed so as to extend along the longitudinal direction. A cell stack 110 is provided on the metal member 105. That is, the metal member 105 is provided at an upper side of the bottom plate of the case main body 101 and at the lower side of the cell stack 110, and is a heat removal member for removing heat from the cell stack 110 to the outside of the case 100.

Here, as shown in FIG. 6, the metal member 105 is disposed between the pair of rails 106 so as to extend in the longitudinal direction of the case main body 101. That is, the metal member 105 is provided so as not to overlap the pair of rails 106 in XY plan view. Due to the shape of the metal member 105 and the arrangement relationship with the rails 106, if the replaceable battery 1 falls and lands with its bottom surface down, the bottom plate of the case main body 101 pushed by the metal member 105 can be deformed so as to protrude to the lower side. As a result, damage to the cell stack 110 caused by the metal member 105 can be suppressed.

A plurality of metal members 105 may be provided.

Although not particularly limited, in the example shown in FIG. 6, the metal member 105 is provided at the center of the cell stack 110 in the widthwise direction of the cell stack and disposed centrally between the pair of rails 106. With such a configuration, when the replaceable battery 1 falls, damage to the cell stack 110 caused by the metal member 105 can be suppressed more effectively.

Although not particularly limited, in the example shown in FIG. 6, the pair of rails 106 are provided at positions corresponding to both ends of the cell stack 110 in the widthwise direction of the cell stack. With such a configuration, when the replaceable battery 1 falls, damage to the cell stack 110 caused by the metal member 105 can be suppressed more effectively, and the replaceable battery 1 can be slid along the pair of rails 106 while having the case 100 including the cell stack 110 stably supported.

Although not particularly limited, the metal member 105 is made of, for example, aluminum or an aluminum alloy having excellent thermal conductivity (i.e., an aluminum-based metal).

Note that the metal member 105 may be made of a metal containing copper having excellent thermal conductivity as its main component, and the replaceable battery 1 can be reduced in weight by being made of an aluminum-based metal.

Furthermore, it is necessary to electrically insulate the metal member 105 and the cell stack 110. Therefore, the contact surface of the metal member 105 with the cell stack 110 is coated with an insulating film having thermal conductivity, for example. Aluminum is suitable for the metal member 105 since aluminum has a dense oxide film formed on the surface thereof.

Thereafter, the cell stack 110 having a rectangular parallelepiped shape is arranged at the upper side of the bottom plate of the lower case 101b close to the side plate of the lower case 101b (Step S102). The cell stack 110 is formed by stacking a plurality of battery cells, the plurality of battery cells being bound together with a binding member 111 such as binding band into a rectangular parallelepiped shape.

Thereafter, electronic apparatuses such as a junction box 108 including a relay and the like and a battery monitoring apparatus 107 are further disposed on the upper side of the bottom plate of the lower case 101b (Step S103). The battery monitoring apparatus 107 includes a voltage measurement apparatus for measuring the voltage of the cell stack 110 and the voltage of each battery cell configuring the cell stack. The battery monitoring apparatus 107 is arranged in a spatial area between the cell stack 110 and the side plate of the upper case 101a to be described later at the upper side of the bottom plate of the lower case 101b. The spatial area is formed by arranging the cell stack 110 so as to be close to the side plate of the lower case 101b. The junction box 108 is arranged in the spatial area between the rear end of the cell stack 110 and the rear case 103 to be described later.

The inner-side case 102a of the front case 102 is disposed at the front end of the lower case 101b (the case main body 101) (Step S103). The rear case 103 including the connector 104 is disposed at the rear end of the lower case 101b (the case main body 101) (Step S103).

Then, an upper case (a second case member) 101a forming the top plate and the other side plate (a second side plate) of the case main body 101 is disposed so as to face the lower case 101b (Step S104). The upper case 101a is formed so that the YZ cross section thereof has an L-shape and so that it extends along the X-axis direction. The rectangular tube-shaped case main body 101 is formed of the upper case 101a and the lower case 101b.

A spatial area 160 is provided above the cell stack 110 in the internal area of the case main body 101. The spatial area 160 is also used as a smoke exhaust area from which gas generated in the cell stack 110 is released. For example, gas generated in the cell stack 110 is discharged from the spatial area 160 to the outside of the case 100 via the relief valve 132. Since the relief valve 132 is provided at the upper edge of the rear case 103, gas generated from the cell stack 110 can be efficiently discharged from the spatial area 160 above the cell stack 110 through the relief valve 132.

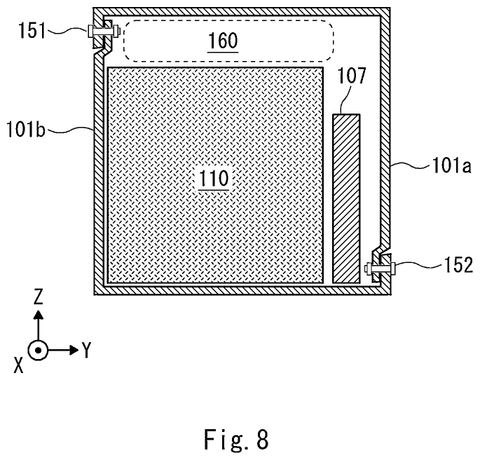

Further, the upper case 101a is fastened to the lower case 101b with fastening members 151 and 152 (Step S104). FIG. 8 is a schematic cross-sectional view of the replaceable battery 1. As shown in FIG. 8, an upper end portion of the lower case 101b that protrudes from the spatial area 160 at the side plate is fastened to an end of the top plate formed by the upper case 101a with the fastening member 151. Further, the lower end part of the side plate of the upper case 101a is fastened to the end part of the bottom plate of the lower case 101b with a fastening member 152.

With this configuration, the cell stack 110 can be disposed so as to be close to one side plate of the lower case 101b without being subject to interference of the fastening member 151. Moreover, by arranging the cell stack 110 close to one side plate in the case 100, the electronic apparatus such as the battery monitoring apparatus 107 can be arranged in the spatial area between the cell stack 110 and the other side plate while reducing the height of the case 100. It should be noted that the cell stack 110 need not be arranged close to one side in the case 100, but may be arranged at the center of the case 100.

As described above, the case main body 101 is composed of a pair of upper case 101a and lower case 101b having an L-shaped cross section. Therefore, an object to be accommodated in the case main body 101 such as the cell stack 110 can be easily accommodated at the time of assembly, thereby improving workability. It should be noted that the case main body 101 need not be formed of a pair of the upper case 101a and the lower case 101b each having an L-shaped cross section. For example, the case main body 101 may be formed of an upper case having a U-shaped cross section and a lower case having a flat plate shape, or may be a single cylindrical member.

Thereafter, the outer case 102b of the front case 102 is disposed at the front end of the case main body 101. Thus, the replaceable battery 1 is completed (Step S105). The outer-side case 102b has a cap-like shape, and is attached to the front end of the case main body 101 so that it covers the opening part (the opening end) of the case main body 101 at the front end thereof together with the side surfaces of the case main body 101. By this configuration, it is possible to, before gas is discharged through the relief valve 132, prevent gas from leaking out from the front case 102 side where the worker is working.

As described above, in the replaceable battery 1 according to the present embodiment, the metal member 105 for heat removal is provided in the upper side of bottom plate of the case main body 101 and in lower side of cell stack 110. The metal member 105 is disposed between a pair of rails 106 extending in the longitudinal direction of the case main body 101 so as to extend, in a bar shape, in the longitudinal direction of the case main body 101. Therefore, in the case where the replaceable battery 1 falls and lands with its bottom surface down, the bottom plate of the case main body 101 pushed by the metal member 105 provided at the lower side of cell stack 110 can be deformed so as that the bottom plate protrudes downward, and the damage to the cell stack 110 caused by the metal member 105 can be suppressed.

The present disclosure promotes the use of battery electric vehicles and contributes to carbon neutrality, decarbonization, and Sustainable Development Goals (SDGs).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A replaceable battery comprising:
a cell stack having a rectangular parallelepiped shape, in which a plurality of battery cells are stacked;
a case for accommodating the cell stack; and
a pair of rails fixed to a lower side of a bottom plate of the case and extending in a longitudinal direction of the case,
wherein the replaceable battery is configured to be slid in the longitudinal direction and removably mounted on a vehicle,
wherein a metal member for heat removal is provided on an upper side of the bottom plate and on a lower side of the cell stack, and
wherein the metal member is disposed between the pair of rails so as to extend, in a bar shape, in the longitudinal direction of the case.

2. The replaceable battery according to claim 1, wherein the metal member is provided at a center of the cell stack in a widthwise direction of the cell stack and disposed centrally between the pair of rails.

3. The replaceable battery according to claim 2, wherein the pair of rails are provided at positions corresponding to both ends of the cell stack in the widthwise direction of the cell stack.

4. The replaceable battery according to claim 2, wherein the center of the cell stack in the widthwise direction of the cell stack is offset from a center of the case in a widthwise direction of the case.

5. The replaceable battery according to claim 1, wherein the metal member is an aluminum-based metal.
